(19) United States
(12) Patent Application Publication
(10) Pub. No.: US 2007/0289450 A1
(43) Pub. Date: Dec. 20, 2007

(54) Bamboo charcoal cup

(76) Inventor: Chun-Neng Chan, Taipei (TW)

Correspondence Address: BIRCH STEWART KOLASCH & BIRCH, PO BOX 747, FALLS CHURCH, VA, 22040-0747, US

(21) Appl. No.: 11/453,019

(22) Filed: Jun. 15, 2006

(51) Int. Cl. A47J 31/00

(52) U.S. Cl. 99/275; 99/323

(57) ABSTRACT

The present invention discloses a cup, particularly a bamboo charcoal cup containing bamboo charcoal, which comprises a cup body whose internal part can load liquids or foods. The bamboo charcoal cup is composed of bamboo charcoal material which is refined under high temperature and may emit the natural far infrared-ray (IR). After examination, the average emission rate of the bamboo charcoal is 83.7% to 91%, and its measured wavelength is 8 to 12 m. These properties are consensus with those of the far IR emitted from human body. Such far IR therefore belongs to the health care class. It could benefit our health if we use the bamboo charcoal cup for a long time. For the injured people or the patients who tend to be tired and ache, the bamboo charcoal cup is a very good health care tool.

### FIELD OF INVENTION

The present invention is related to a cup, in particular to a bamboo charcoal cup.

### BACKGROUND OF THE INVENTION

In the prior art, the conventional cups are usually made from glass, PVC plastics, woods or stainless steel materials. The cups made from PVC plastic material cannot resist high temperature and may be easily decomposed to release the carcinogenic chemicals when heated for a long time. This may dramatically reduce the half-life of the products. For the environment protection concepts, many countries have forbidden the use of some traditional materials which are not easily degraded in nature. Therefore, it is still needed to look for some novel materials, which are environment-friendly and good for health care.

For this purpose, the present invention provides a bamboo charcoal cup to overcome the disadvantages of the prior art.

### SUMMARY OF THE INVENTION

The main purpose of the present invention is to provide a cup containing bamboo charcoal, which is combined traditional bamboo charcoal material and currently used cup to form a novel bamboo charcoal cup. The far IR emitted from the natural bamboo charcoal is similar to those from human body and could thus benefit our health and provide health care functions.

Another purpose of the present invention is to use the far IR emitted from the bamboo charcoal to promote the blood circulation and stabilize blood pressure. It could also promote the metabolism and clarify the blood. As the results, the weakness and coldness problem of the limbs could be resolved and our immunity could be increased. Also, it helps the blood circulate through the whole body and reduces the tiredness. These excellent functions elevate the value of the bamboo charcoal.

Still another purpose of the present invention is to provide a bamboo charcoal cup made from bamboo charcoal, which may not be degraded to release carcinogens when heated. Even when it is disposed, it is easily degraded by the natural substances and is good for environmental protection.

The present invention discloses a cup, particularly a bamboo charcoal cup containing bamboo charcoal, which comprises a cup body whose internal part can load liquids or foods. The bamboo charcoal cup is composed of bamboo charcoal material which is refined under high temperature and may emit the natural far infrared-ray (IR). After the examination, the average emission rate of the bamboo charcoal is 83.7% to 91%, and its measured wavelength is 8 to 12 m. These properties are consensus with those of the far IR emitting from human body. Such far IR therefore belongs to the health care class. It could benefit our health if we use the bamboo charcoal cup for a long time. For the injured people or the patients who tend to be tired and ache, the bamboo charcoal cup is a very good health care tool.

The following example illustrates the present invention with drawings, which make the purpose, the techniques, the characters and effects of the invention become apparent.

### BRIEF DESCRIPTION OF THE DRAWINGS

FIG. 1 is a perspective view of a bamboo charcoal cup of the present invention;

FIG. 2 is a cross-section view of the bamboo charcoal cup of the present invention.

### DETAILED DESCRIPTION OF THE PREFERRED EMBODIMENT

For making the characters and advantages of the present invention more apparent to examiners, the following example illustrates the present invention with drawings:

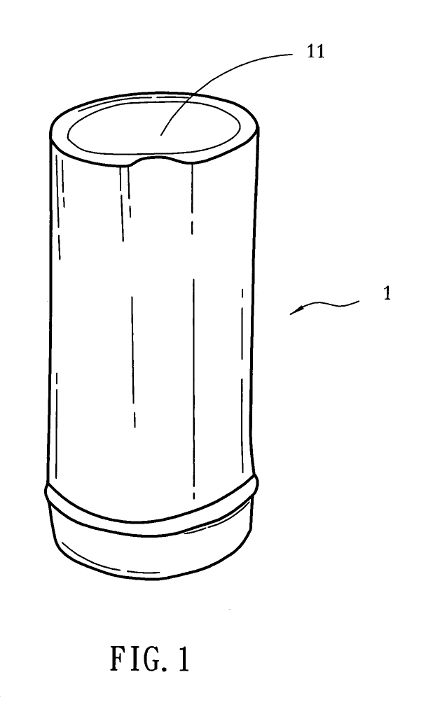

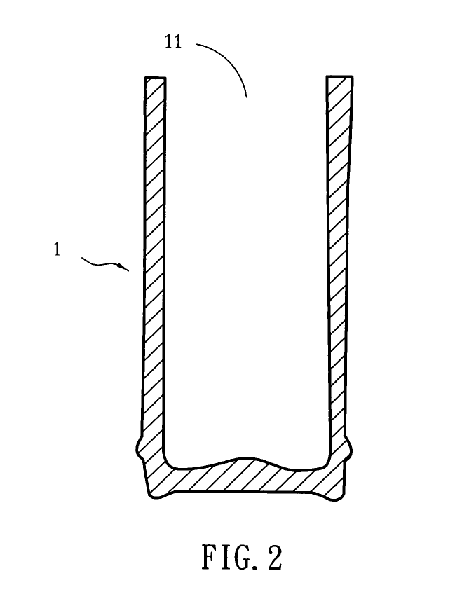

Please refer to FIG. 1, which is a perspective view of a bamboo charcoal cup of the present invention, and FIG. 2, which is a cross-section view of the bamboo charcoal cup of the present invention. As shown in the figures, there is a cup body 1, and an internal part of the cup 1 is an accommodating space 11, which could load drinking liquid or foods and is more convenient to use the cup 1. Besides, the cup made from bamboo charcoal is high-temperature resistant and could avoid the disadvantages of conventional PVC plastic cups which are easily decomposed to release carcinogens when heated. The cup 1 is more environment-friendly and easier to be degraded in nature. The shape of cup 1 is not limited during manufacture. Any shape of cup 1 could be made. Moreover, the far IR emitted from the bamboo charcoal could promote the blood circulation and stabilize the blood pressure. It could also promote the metabolism and clarify the blood. As the results, the weakness and coldness problem of the limbs could be resolved and our immunity could be increased. Also, it helps the blood circulate through the whole body and reduces the tiredness. These excellent functions elevate the value of the bamboo charcoal.

The bamboo charcoal cup disclosed above comprises a cup body whose internal part can load liquid; the bamboo charcoal cup is composed of bamboo charcoal material which is refined under high temperature and may emit the natural far infrared-ray (IR). After examination, the average emission rate of the bamboo charcoal is 83.7% to 91%, and its measured wavelength is 8 to 12 m. These properties are consensus with those of the far IR emitting from human body. Such far IR therefore belongs to the health care class. It could benefit our health if we use the bamboo charcoal cup for a long time. For the injured people or the patients who tend to be tired and ache, the bamboo charcoal cup is a very good health care tool.

From the descriptions above, we know that the present invention provides an improved function with the novel techniques, which is not easily designed by the one who skills in the art. In addition, the present invention has not been published. The present invention exhibits non-obviousness and utility, fulfilling the requirements of the invention patents.

It should be understood that the foregoing descriptions and examples are only illustrative of the invention. It will become apparent to those skilled in the art, not to limit the scope of the invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

What is claimed is:

1. A bamboo charcoal cup, comprising a cup body which is made from bamboo charcoal, wherein an internal part of the cup has an accommodating space to load drinking liquid.

2. The bamboo charcoal cup as claimed in claim 1, wherein a shape of said cup is any kind of shape.

3. The bamboo charcoal cup as claimed in claim 1, wherein said cup is composed of bamboo charcoal material which is refined under high temperature.

4. The bamboo charcoal cup as claimed in claim 1, wherein the accommodating space is to accommodate foods.
